(19) United States
(12) Patent Application Publication
(10) Pub. No.: US 2006/0212572 A1
(43) Pub. Date: Sep. 21, 2006

(54) Protecting against malicious traffic

(76) Inventors: Yehuda Afek, Hod Hasharon (IL); Rafi Zadikario, Kfar Saba (IL); Dan Touitou, Ramat Gan (IL); Anat Bremler Bar, Ramat-Ha'Sharon (IL)

Correspondence Address: DARBY & DARBY P.C., P. O. BOX 5257, NEW YORK, NY, 10150-5257, US

(21) Appl. No.: 11/183,091

(22) Filed: Jul. 14, 2005

Related U.S. Application Data
(63) Continuation of application No. 10/498,463, now abandoned.
Application No. 10/498,463 is a continuation-in-part of application No. 09/929,877, filed on Aug. 14, 2001.
(60) Provisional application No. 60/240,899, filed on Oct. 17, 2000.
(60) Provisional application No. 60/339,900, filed on Dec. 10, 2001.

(51) Int. Cl. G06F 15/16; G06F 15/173

(52) U.S. Cl. 709/225; 709/206

(57) ABSTRACT

A method for screening packet-based communication traffic. At least a first data packet, sent over a network from a source address to a destination address, is received. A determination is made, by analyzing the first data packet, that the first data packet was generated by a worm. In response to the determination, a second data packet sent over the network from the source address is blocked.

### CROSS-REFERENCE TO RELATED APPLICATIONS

This application claims the benefit of U.S. Provisional Patent Application No. 60/339,900, filed Dec. 10, 2001, entitled, “Methods and Apparatus for Protecting Against Malicious Traffic in the Internet.” This application is a continuation-in-part of co-pending U.S. patent application Ser. No. 09/929,877, filed Aug. 14, 2001, published as U.S. Patent Application Publication 20020083175, entitled “Methods and Apparatus for Protecting Against Overload Conditions on Nodes of a Distributed Network.” Both of these related applications are assigned to the assignee of the present patent application, and their disclosures are incorporated herein by reference.

### FIELD OF THE INVENTION

The present invention relates generally to computer networks, and specifically to methods and systems for protecting against malicious traffic in computer networks.

### BACKGROUND OF THE INVENTION

In a Denial-of-Service (DoS) attack, an attacker bombards a victim network or server with a large volume of message traffic. The traffic overload consumes the victim's available bandwidth, CPU capacity, or other critical system resources, and eventually brings the victim to a situation in which it is unable to serve its legitimate clients. Distributed DoS (DDoS) attacks can be even more damaging, as they involve creating artificial network traffic from multiple sources simultaneously. In a “conventional” massive-bandwidth attack, the source of the attack may be traced with the help of statistical analysis of the source Internet Protocol (IP) addresses of incoming packets. The victim can subsequently filter out any traffic originating from the suspect IP addresses, and can use the evidence to take legal action against the attacker. Many attacks, however, now use “spoofed” IP packets—packets containing a bogus IP source address—making it more difficult for the victim network to defend itself against attack.

In order to launch an effective DDoS attack, an attacker typically attempts to control a large number of servers on the Internet. One approach to gaining such control is to use “worms,” which are programs that self-replicate across the Internet by exploiting security flaws in widely-used services. After taking control of a server, a worm often uses the server to participate in a DDoS attack. Recent well-known worms include Code Red (I and II) and Nimba. For example, Code Red I spread during the summer of 2001 by exploiting a security flaw in Microsoft® IIS web servers. Once it infected a server, the worm spread by launching 99 threads, each of which generated random IP addresses and attempted to compromise servers at these addresses. In addition to this self-replication, Code Red I self-activated simultaneously on infected servers to launch a coordinated DDoS attack on the www.whitehouse.gov domain.

In addition to the disruption caused to domains that are victims of a DDoS attack launched by a worm, the servers and networks infected by the worm often experience performance degradations. Such degradations are caused in part by the packets generated and received by an infected server as it attempts to discover and infect servers at random IP addresses (called “scanning”), and by the packets generating by the infected server when it participates in a DDoS attack. For example, an infected server may send a large volume of SYN request packets to random IP addresses, each of which may respond with a SYN-ACK response packet. Such traffic may consume a large portion of the bandwidth of the connection of the infected network with the Internet. Additionally, SYN requests are typically buffered by the sending server for a period of time, tying up server resources.

### SUMMARY OF THE INVENTION

In embodiments of the present invention, a network guard system detects and blocks incoming and/or outgoing packets generated by a worm. Typically, the guard system detects such infected packets by (a) checking whether the packets contain a known worm signature, and/or (b) monitoring the sources of the packets for anomalous traffic patterns that correspond to patterns associated with worm-generated traffic. Once the guard system detects a suspicious packet or traffic pattern, it may block all or a portion of the packets from the same source for a period of time or take other preventive action. Non-infected packets are forwarded to their intended destinations.

For some applications, the network guard system monitors incoming packets, in order to prevent a malicious source from establishing connections with servers within a protected area of a network. In some such embodiments of the present invention, a network protected with the network guard system designates a set of network addresses (such as IP addresses) assigned to the network as “trap” addresses. These trap addresses are assigned to one or more guard devices, but otherwise are not used by other elements of the network. When a packet addressed to such a trap address enters the protected network, the packet is forwarded to the assigned guard device, which analyzes the traffic. The guard device may determine that the traffic from a given source address is suspicious, based on the content or statistical properties of the traffic, for example. The guard device may then block or otherwise filter incoming traffic from the suspicious source address, to reduce the likelihood of servers within the protected area of a network becoming infected with a worm. Alternatively or additionally, the guard device may then begin monitoring all packets entering the protected area of the network. These techniques for protecting against incoming worm-generated traffic can reduce bandwidth consumption between the protected network and a wide-area network, such as the Internet. For example, these techniques may reduce outgoing traffic generated by elements in the protected area in response to the incoming traffic, such as SYN-ACK responses generated by internal servers when attempting to establish a handshake with infected external servers.

Alternatively or additionally, the network guard system monitors outgoing packets originating from servers in a protected area. Typically, the guard system detects an infected server by determining that the server is attempting to create a large number of connections to different addresses within a short time, or to create a connection with a non-existing address. By detecting and blocking infected outgoing packets, the guard system prevents servers infected with a worm from establishing specific types of connections with servers outside the protected area. This technique can also reduce bandwidth consumption between the protected network and a wide-area network, such as the Internet, (a) by reducing outbound traffic generated by servers infected with a worm, both when the servers attempt to propagate the worm and when they participate in a DDoS attack, and (b) by reducing inbound traffic generated in response to the malicious outbound traffic, such as SYN-ACK responses generated by external servers when attempting to establish a handshake with infected internal servers. Additionally, upon detecting an infected server, the guard system typically generates a network administrator alert, so that the administrator can take appropriate action, such as cleaning infected servers.

The techniques of worm-generated traffic detection and diversion described herein may be used on their own, or in combination with other, complementary techniques for preventing DDoS attacks. Such techniques are described, for example, in the above-referenced US Patent Application Publication 20020083175, and in U.S. patent application Ser. No. 10/232,993, filed Aug. 29, 2002, entitled, “Protecting Against Distributed Denial of Service Attacks,” which are assigned to the assignee of the present patent application and are incorporated herein by reference.

There is therefore provided, in accordance with an embodiment of the present invention, a method for screening packet-based communication traffic, including:

receiving at least a first data packet sent over a network from a source address to a destination address;

making a determination, by analyzing the first data packet, that the first data packet was generated by a worm; and

in response to the determination, blocking a second data packet sent over the network from the source address.

Making the determination may include comparing an attribute of the first data packet with a set of attributes of known worm-generated packets, and blocking the first data packet when the attribute of the first data packet is found to match one of the attributes in the set.

In an embodiment, blocking the second data packet includes blocking the second data packet during a period of time commencing with making the determination that the first data packet was generated by the worm, and not blocking the second data packet thereafter.

In an embodiment, the destination address is located within a protected area of the network, and receiving the first data packet includes receiving the first data packet from a source located outside the protected area. Alternatively, the source address belongs to a network element located within a protected area of the network, the destination address is located outside the protected area, and receiving the first data packet includes receiving the first data packet within the protected area.

Making the determination may include generating an administrator alert that the first data packet was generated by the worm.

In an embodiment, the first data packet has a port designation, and making the determination includes determining that the port designation does not correspond to an application running at the destination address. Alternatively or additionally, a server for an application resides at the destination address, and making the determination includes determining that the first data packet does not correspond to the application.

In an embodiment, receiving the first data packet includes receiving an Internet Protocol (IP) packet, and making the determination includes analyzing a pattern of a sequence number of the IP packet. Alternatively or additionally, receiving the first data packet includes receiving a Transport Control Protocol (TCP) SYN packet. Receiving the SYN packet may include receiving multiple SYN packets addressed to multiple, respective destination addresses, and making the determination includes detecting a pattern of address scanning characteristic of the worm.

In an embodiment, making the determination includes determining that the destination address is invalid. Making the determination may include designating one or more addresses as trap addresses, and determining that the destination address is one of the trap addresses. Making the determination may also include analyzing a rate of arrival of data packets sent from the source address to one or more of the trap addresses, so as to determine whether the packets were generated by the worm.

In an embodiment, making the determination includes storing on a blacklist the source address of the first data packet, and blocking the second data packet includes blocking the second data packet in response to the blacklist. Storing on the blacklist may include removing the source address of the first data packet from the blacklist when it is determined that a rate of packets received from the source address has decreased.

Receiving at least the first data packet may include receiving multiple data packets from the source address, which are addressed to a plurality of respective destination addresses, and making the determination includes analyzing the multiple data packets sent from the source address. Making the determination may include analyzing a rate of arrival of the data packets. Alternatively or additionally, making the determination includes comparing a pattern of the destination addresses with at least one pattern associated with known worm-generated traffic. Receiving the data packets from the source address may include receiving the data packets from a plurality of source addresses belonging to a subnetwork, and blocking the second data packet includes blocking further data packets sent over the network from the subnetwork.

In an embodiment, receiving the first data packet includes intercepting the first data packet before the first data packet reaches the destination address, and the method includes delivering the first data packet to the destination address when it is determined that the first data packet was not generated by the worm. Receiving the first data packet may include receiving an Internet Protocol (IP) packet addressed to a particular port, and intercepting the first data packet includes intercepting the first data packet responsively to the particular port to which the IP packet is addressed. Intercepting the first data packet may include intercepting the first data packet only if the first data packet includes a Transport Control Protocol (TCP) SYN packet and the first data packet is addressed to port 80.

There is also provided, in accordance with an embodiment of the present invention, a method for analyzing packet-based communication traffic, including:

receiving multiple data packets sent over a network from a source address and addressed to a plurality of respective destination addresses;

determining a rate of sending the data packets to the plurality of destination addresses from the source address; and

in response to the rate, designating the source address as a source of malicious traffic.

Receiving the data packets may include receiving Transport Control Protocol (TCP) SYN packets. Designating the source address may include designating the source address as a generator of worm-generated traffic.

In an embodiment, receiving the data packets includes receiving Internet Protocol (IP) packets having respective port designations, and determining the rate includes determining the rate of sending the data packets whose respective port designations do not correspond to applications running at the destination addresses. Determining the rate may include determining the rate of sending data packets addressed to the destination addresses at which reside servers for an application, which application is different from that specified in the packets.

There is further provided, in accordance with an embodiment of the present invention, a method for analyzing packet-based communication traffic, including:

designating one or more network addresses as trap addresses;

receiving a data packet sent over the network from a source address to one of the trap addresses; and

in response to receiving the packet, designating the source address as a source of malicious traffic.

In an embodiment, receiving the data packet includes receiving a plurality of data packets sent over the network from the source address to one or more of the trap addresses, and designating the source address includes analyzing a rate of arrival of the data packets sent from the source address to the one or more of the trap addresses. Designating the source address may include designating the source address as a generator of worm-generated traffic.

There is still further provided, in accordance with an embodiment of the present invention, a method for analyzing packet-based communication traffic, including:

designating one or more network addresses as trap addresses;

receiving a data packet sent over the network to one of the trap addresses; and

in response to receiving the packet, initiating diversion of further data packets sent over the network from sources outside a protected area of the network, so as to prevent malicious traffic from reaching the protected area of the network.

Initiating diversion may include initiating diversion so as to prevent worm-generated traffic from reaching the protected area of the network. In an embodiment, initiating diversion includes determining that one of the further data packets was generated by a worm, and, in response to the determination, blocking the delivery of the packet. Receiving the data packet may include receiving a plurality of data packets sent over the network from a source address to one or more of the trap addresses, and initiating diversion includes analyzing a rate of arrival of the data packets sent from the source address to the one or more of the trap addresses.

There is additionally provided, in accordance with an embodiment of the present invention, a method for analyzing packet-based communication traffic, including:

receiving a data packet sent over a network from a source address to a destination address;

comparing an attribute of the data packet with a set of attributes of known worm-generated packets; and

designating the source address as a source of worm-generated traffic when the attribute of the packet is found to match one of the attributes in the set.

The attribute may include a length of the data packet or a signature of the packet.

There is yet additionally provided, in accordance with an embodiment of the present invention, apparatus for screening packet-based communication traffic, including a guard device, which is adapted to receive at least a first data packet sent over a network from a source address to a destination address, to make a determination, by analyzing the first data packet, that the first data packet was generated by a worm, and, in response to the determination, to block a second data packet sent over the network from the source address.

There is also provided, in accordance with an embodiment of the present invention, apparatus for analyzing packet-based communication traffic, including a guard device, which is adapted to receive multiple data packets sent over a network from a source address and addressed to a plurality of respective destination addresses, to determine a rate of sending the data packets to the plurality of destination addresses from the source address, and, in response to the rate, to designate the source address as a source of malicious traffic.

There is further provided, in accordance with an embodiment of the present invention, apparatus for analyzing packet-based communication traffic, including a guard device, which is adapted to designate one or more network addresses as trap addresses, to receive a data packet sent over the network from -a source address to one of the trap addresses, and, in response to receiving the packet, to designate the source address as a source of malicious traffic.

There is still further provided, in accordance with an embodiment of the present invention, apparatus for analyzing packet-based communication traffic, including a guard device, which is adapted to designate one or more network addresses as trap addresses, to receive a data packet sent over the network to one of the trap addresses, and, in response to receiving the packet, to initiate diversion of further data packets sent over the network from sources outside a protected area of the network, so as to prevent malicious traffic from reaching the protected area of the network.

There is additionally provided, in accordance with an embodiment of the present invention, apparatus for analyzing packet-based communication traffic, including a guard device, which is adapted to receive a data packet sent over a network from a source address to a destination address, to compare an attribute of the data packet with a set of attributes of known worm-generated packets, and to designate the source address as a source of worm-generated traffic when the attribute of the packet is found to match one of the attributes in the set.

There is yet additionally provided, in accordance with an embodiment of the present invention, a computer software product for screening packet-based communication traffic, the product. including a computer-readable medium in which program instructions are stored, which instructions, when read by a computer, cause the computer to receive at least a first data packet sent over a network from a source address to a destination address, to make a determination, by analyzing the first data packet, that the first data packet was generated by a worm, and, in response to the determination, to block a second data packet sent over the network from the source address.

There is also provided, in accordance with an embodiment of the present invention, a computer software product for analyzing packet-based communication traffic, the product including a computer-readable medium in which program instructions are stored, which instructions, when read by a computer, cause the computer to receive multiple data packets sent over a network from a source address and addressed to a plurality of respective destination addresses, to determine a rate of sending the data packets to the plurality of destination addresses from the source address, and, in response to the rate, to designate the source address as a source of malicious traffic.

There is further provided, in accordance with an embodiment of the present invention, a computer software product for analyzing packet-based communication traffic, the product including a computer-readable medium in which program instructions are stored, which instructions, when read by a computer, cause the computer to designate one or more network addresses as trap addresses, to receive a data packet sent over the network from a source address to one of the trap addresses, and, in response to receiving the packet, to designate the source address as a source of malicious traffic.

There is still further provided, in accordance with an embodiment of the present invention, a computer software product for analyzing packet-based communication traffic, the product including a computer-readable medium in which program instructions are stored, which instructions, when read by a computer, cause the computer to designate one or more network addresses as trap addresses, to receive a data packet sent over the network to one of the trap addresses, and, in response to receiving the packet, to initiate diversion of further data packets sent over the network from sources outside a protected area of the network, so as to prevent malicious traffic from reaching the protected area of the network.

There is additionally provided, in accordance with an embodiment of the present invention, a computer software product for analyzing packet-based communication traffic, the product including a computer-readable medium in which program instructions are stored, which instructions, when read by a computer, cause the computer to receive a data packet sent over a network from a source address to a destination address, to compare an attribute of the data packet with a set of attributes of known worm-generated packets, and to designate the source address as a source of worm-generated traffic when the attribute of the packet is found to match one of the attributes in the set.

The present invention will be more fully understood from the following detailed description of embodiments thereof, taken together with the drawings in which:

### BRIEF DESCRIPTION OF THE DRAWINGS

FIG. 1 is a block diagram that schematically illustrates a network guard system, in accordance with an embodiment of the present invention;

FIG. 2 is a block diagram that schematically illustrates a network guard system deployed by. an Internet Service Provider (ISP), in accordance with an. embodiment of the present invention; FIG. 3 is a flow chart that schematically illustrates a method for detecting worm-generated traffic, in accordance with an embodiment of the present invention;

FIG. 4 is a flow chart that schematically illustrates a method for screening and blocking traffic, in accordance with an embodiment of the present invention; and

FIG. 5 is a flow chart that schematically illustrates another method for detecting worm-generated traffic, in accordance with an embodiment of the present invention.

### DETAILED DESCRIPTION OF EMBODIMENTS

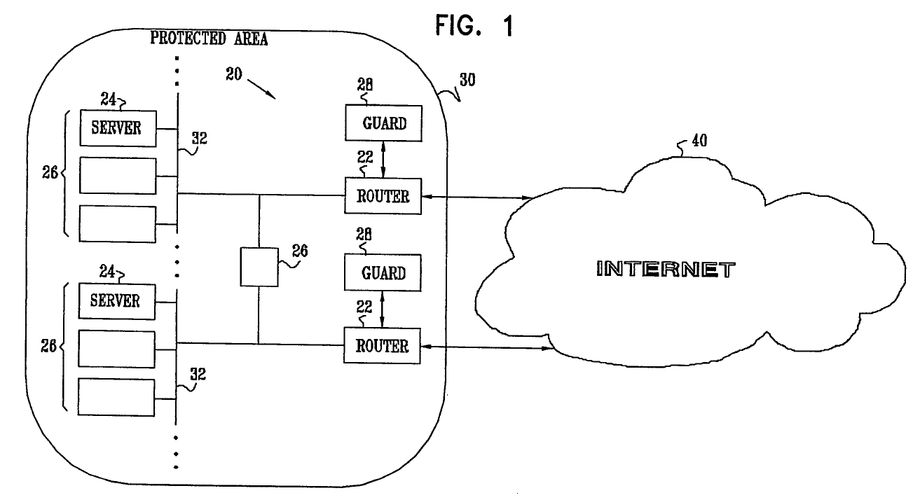

FIG. 1 is a block diagram that schematically illustrates a network guard system 20, in accordance with an embodiment of the present invention. A protected area 30 of a network communicates with a wide-area network (WAN) 40, typically the Internet, through one or more routers 22. Protected area 30 comprises various network elements 26, such as servers 24, clients, switches, internal routers, and bridges, typically connected by one or more local-area networks (LANs) 32. Typically, although not necessarily, protected area 30 comprises a private network, such as an enterprise or campus network, or a network operated by an Internet Service Provider (ISP), as described below.

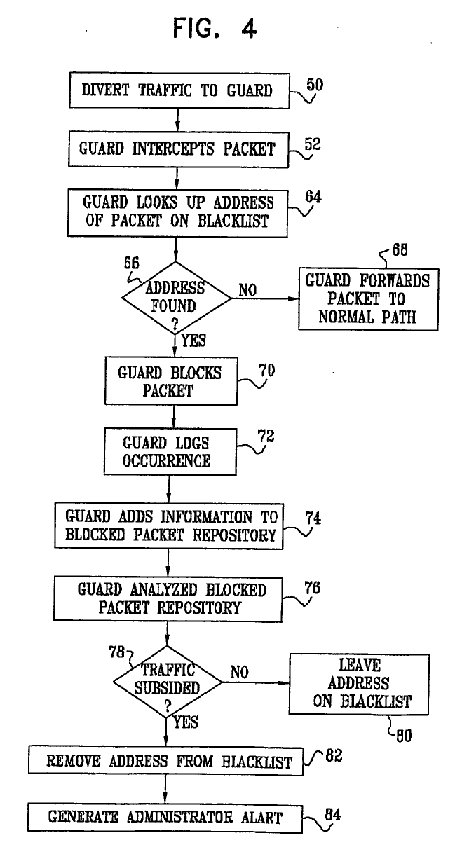

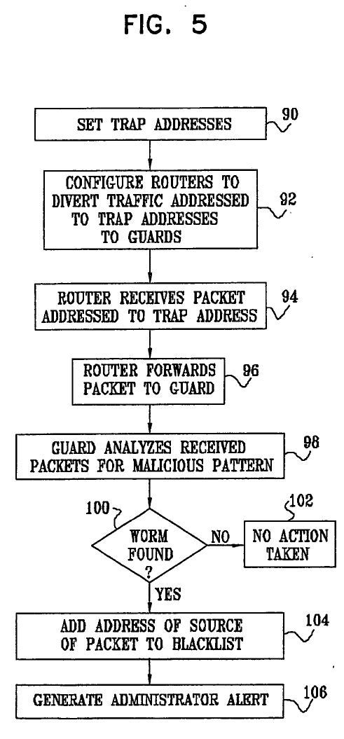

To prevent the infection of servers 24 with a worm, a guard device 28 intercepts incoming packets from WAN 40 that are addressed to network elements 26. Guard device 28 analyzes these incoming packets in order to detect packets that are suspected of being infected with a worm, typically using techniques described hereinbelow with reference to FIGS. 3 and 5. Once an infected packet or traffic pattern has been detected, guard device 28 blocks all or a portion of the packets from the same source for a period of time, typically using techniques described hereinbelow with reference to FIG. 4. Non-infected packets are forwarded to their intended destinations.

Alternatively or additionally, guard device 28 monitors outgoing packets sent from servers 24 via WAN 40 to network elements outside protected area 30. By detecting and blocking infected outgoing packets, guard device 28 prevents servers 24 infected with a worm from establishing connections with servers outside protected area 30. As a result, infected servers 24 are not able to compromise outside servers or to participate in a DDoS attack on network elements outside protected area 30. Blocking such infected traffic also relieves pressure on the links between routers 22 and WAN 40, so that legitimate traffic is not impeded by malicious activity.

Guard device 28 may perform these packet screening and diversion functions at all times, or it may alternatively become active only under stress conditions, in which a worm attack on or by servers 24 is expected or suspected. For example, guard device 28 may become active when an unusually large number of incoming SYN request packets is detected, when other traffic statistics indicate that an attack may be in progress, when worm-generated traffic has been detected using “trap” addresses, as described hereinbelow with reference to FIG. 5, and/or when a network administrator is aware that a worm is active over the Internet.

Typically, guard device 28 comprises a general-purpose computer, which is programmed in software to carry out the functions described herein. The software may be downloaded to the computer in electronic form, over a network, for example, or it may alternatively be supplied to the computer on tangible media, such as CD-ROM. Further alternatively, guard device 28 may be implemented in dedicated hardware logic, or using a combination of hardware and software elements. The guard device may be a standalone unit, or it may alternatively be integrated with other communication or computing equipment, such as router 22, a firewall, or an intrusion detection system (not shown).

In practical applications, one or more guard devices 28 may be used to protect a cluster of servers 24, or they may be used to protect an entire LAN, intranet or a collection of servers whose traffic is diverted to the guard devices. The guard functionality may be distributed among multiple guard devices 28, at one or more access points to protected area 30. In applications using more than one guard device, the guard devices may share one or more common data repositories, or may otherwise communicate with each other, such as for performing aggregated statistical analysis and/or maintaining a common record of suspected sources of malicious packets. The guard devices may be deployed in configurations similar to firewalls known in the art. Preferably, the guard devices have sufficient processing capacity so that they do not themselves become a bottleneck in the case of a worm attack. While certain techniques are described herein with respect to screening incoming and/or outgoing traffic to/from servers 24, these techniques may also be used to screen incoming and/or outgoing traffic to/from other network elements 26, such as client computers, that are capable of being infected with a worm. Routers 28 may comprise routers of the type commercially available and commonly used on an IP network, or other network elements capable of redirecting traffic and otherwise providing the functions commonly performed by routers.

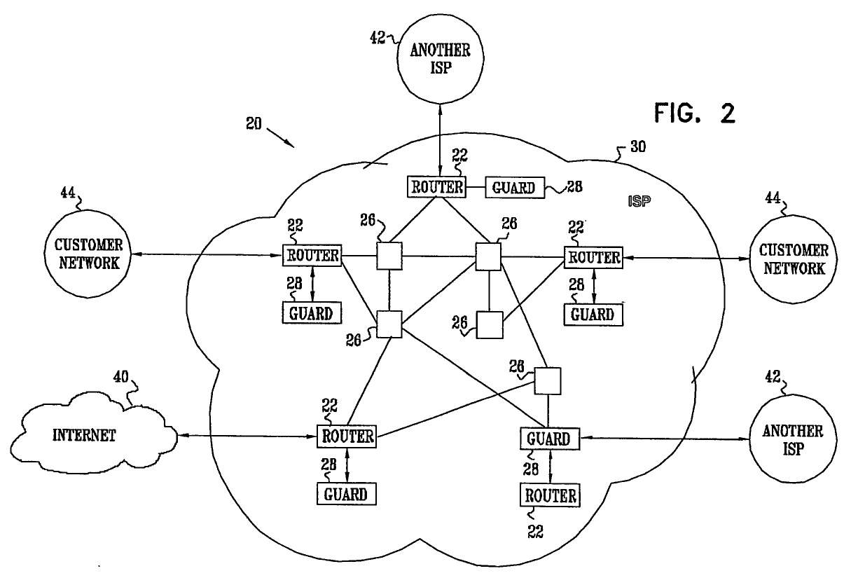

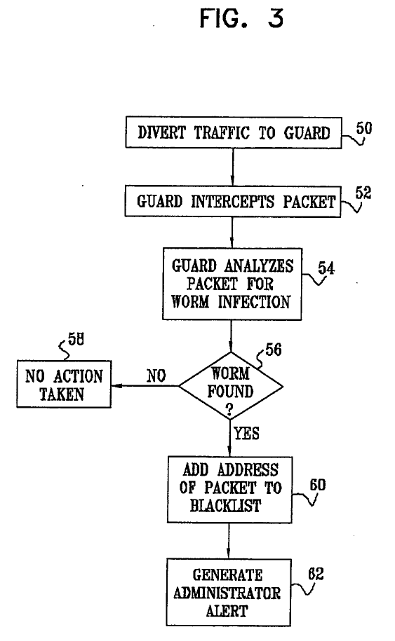

FIG. 2 is a block diagram that schematically illustrates a network guard system 20 deployed on protected area 30 of a network belonging to an Internet Service Provider (ISP), in accordance with an embodiment of the present invention. Protected area 30 typically communicates through one or more routers 22 with external networks, such as (a) a public wide-area network (WAN) 40, typically the Internet, as noted above, as well as (b) other ISPs 42, either at private or public peering points, and (c) networks 44 of customers. Protected area 30 comprises various network elements 26, such as routers, switches, bridges, servers, and clients. One or more guard devices 28 process incoming and/or outgoing packets from/to external networks. Typically, each guard device is connected in a lollipop fashion to one of the ports of a corresponding router. The router passes certain incoming and/or outgoing packets (or, in some circumstances, all incoming and/or outgoing packets) to the guard device for analysis, based on preprogrammed routing criteria Guard devices 28 analyze the packets in order to prevent the spread of worms and/or worm-generated traffic between different external networks and between external networks and network elements 26, using the techniques described herein.

Although in FIGS. 1 and 2 each guard device 28 is shown connected directly with a single adjacent router 22, alternative configurations will be apparent to those skilled in the art, having read the present patent application. For example, there need not be a one-to-one correspondence between guard devices and routers, and guard devices and routers may be separated by physical or network distance, such as by a switch.

FIG. 3 is a flow chart that schematically illustrates a method for detecting worm-generated traffic, in accordance with an embodiment of the present invention. The method may be carried out at all times, or only at certain times or under certain circumstances, depending on the configuration of guard device and router in question. For example, the method may be initiated when a stress condition has been manually or automatically detected, or from time to time for sampling of traffic. Upon initiation, all or selected types of traffic are diverted from router 22 to guard device 28, at a traffic diversion step 50. Preferably, only types of traffic that could potentially carry a worm are diverted. For example, responsive to specific network configurations and conditions, only traffic to ports corresponding to certain applications may be diverted (e.g., port 80 for HTTP applications, or port 21 for FTP applications). To minimnize the diversion of traffic, for some applications it may be sufficient to divert only port 80 SYN packets, which diversion enables the blocking of the spread of worms over applications that run over HTTP.

In some embodiments of the present invention, diversion is effected using one or more of the following techniques:
The Web Cache Coordination Protocol (WCCP) version 1 (promulgated by Cisco® Systems, San Jose, Calif. may be used to seamlessly divert all port 80 traffic to guard device 28.
For routers 22 that support WCCP version 2, diversion may be effected using more specific selection criteria, if appropriate. For example, all SYN requests (or all SYN requests to port 80), or only SYN requests or other traffic from particular source IP addresses may be diverted.
Cisco's Policy Based Routing (PBR) may be used to redirect traffic based on criteria specified using access control lists (ACLs), such as destination port, type of packet (e.g., SYN request), or the interface on which the traffic was received.
Diversion may be effected through the issuance of Border Gateway Protocol (BGP) announcements to reroute traffic from its intended recipient to guard device 28.
   Other diversion techniques described in the above-referenced US Patent Application Publication 20020083175, or otherwise known in the art, such as those used for firewalls, may also be used. The diversion techniques of the present invention may be implemented in conjunction with further diversion techniques described in US Patent Application Publication 20020083175.

Returning now to FIG. 3, after traffic has been diverted, guard device 28 intercepts all diverted packets, at a packet interception step 52. Guard device 28 analyzes the intercepted packets, individually and/or in aggregate, in order to detect packets that are suspected of being infected with a worm or generated by a worm, at a packet analysis step 54. Such infected packets may carry the worm code itself, and/or they may have been generated by a worm in order to scan for vulnerable servers or prepare the servers to receive the worm code. Additionally, infected packets (typically, primarily outgoing packets) may have been generated by a worm-infected server 24 participating in a DDoS attack.

One or more of the following techniques are typically used for analyzing the packets, depending upon the particular warning in effect, or as determined by a network administrator:
Destination addresses of packets are analyzed to detect patterns indicative of malicious activity. Packets are grouped by source address or by subnetwork source address, and guard device 28 performs one or more of the following analyses:
   According to a first method of analysis, an unusually high rate of packets, such as SYN packets, from the same source or subnetwork source address to multiple destination addresses is interpreted as an indication of worm-generated “scanning” traffic. The analysis may exclude from suspicion sources that normally exhibit such behavior, such as proxy servers, by comparing their activity to their measured baseline activity.
   According to a second method of analysis, an anomalous pattern of destination addresses from the same source or subnetwork source is interpreted as an indication of worm-generated traffic. For example, the anomalous pattern may correspond to the malicious scanning pattern of a known worm, such as Code Red or Nimba. Alternatively, the anomalous pattern may be similar to known or anticipated patterns of behavior of worms.
   According to a third method of analysis, packets addressed to invalid destinations, such as non-existing destination addresses, or destination addresses without a server, are considered highly likely to be worm-generated.
   According to a fourth method of analysis, an unusually high rate of packets, typically SYN packets, for a particular application or port, when addressed to destinations that are not servers for the particular application or port, is interpreted as a likely indication of worm-generated traffic. For example, such SYN packets may be addressed either to port 80 of devices that are not HTTP servers, or to addresses not in use.
   According to a fifth method of analysis, parameters of SYN requests or request messages are statistically analyzed to detect patterns indicative of behavior of worm-infected sources. For example, such parameters may include sequence numbers used by a source.
Individual packets are analyzed to detect a signature of a known worm. Preferably, in order to efficiently check packets, packet size is first checked against known worm-bearing packet sizes. Packets with matching sizes are further screened by checking for digital patterns of known worms within the message body. A single occurrence of a known worm is sufficient to definitively identify a malicious source.
Destination addresses of packets are analyzed to detect invalid addresses, which may be indicative of worm-generation of the packets. For example, there are many segments of Internet 1P addresses that are well-known to be unused (e.g., address reserved for testing or multicasting). Additionally, the guard addresses may maintain an up-to-date list of Internet IP addresses that are not currently allocated. Furthermore, addresses designated as “trap” addresses, as described hereinbelow with reference to FIG. 5, are known to be invalid.
   These techniques are generally effective for detecting worm-generated or worm-bearing traffic of both incoming and outgoing traffic. For some applications, some or all of these analysis techniques are implemented using statistical collection and intelligent learning techniques described in the above-referenced US Patent Application Publication 20020083175, mutatis mutandis.

Continuing with the method of FIG. 3, after performing the analysis, a determination is made regarding whether a worm-infected source has been identified, at a worm found checking step 56. If a worm has not been found, the guard device takes no action with respect to the intercepted packet, at a no action step 58. On the other hand, if a worm has been identified, the source address or subnetwork source address, as the case may be, is added to a blacklist of suspected or known worm-infected sources, at a blacklist step 60. The blacklist is stored in a repository, such as a database. (Alternatively, substantially any suitable memory device and data structure may be used for storing blacklist, and not only a database.) When multiple guard devices are deployed in area 30, they preferably, but not necessarily, share a common blacklist, in order to enable more complete blocking of blacklisted sources.

After adding the infected source to the blacklist, guard device 28 typically generates a network administrator alert and/or log entry, at an alert generation step 62. An administrator can use this information to take preventive or corrective steps. For example, when a worm has been detected in outgoing traffic (i.e., a worm infecting a server 24 within protected area 30), the administrator can clean the infected server and install an appropriate patch to correct the security fault that created the vulnerability to infection. In some instances, particularly when a worm has been detected in incoming traffic, an administrator may wish to configure one or more of routers 22 and/or firewalls to block the malicious source directly, without the use of guard devices 28.

Worm scanners (worms configured to scan for vulnerable servers by sending packets to multiple addresses) sometimes use spoofed IP packets, as described in the Background section hereinabove. As a result, a guard device may determine that a certain source address is worm-infected, when in fact the source address was only spoofed by a worm located elsewhere on the WAN. A guard device thus may under certain circumstance erroneously block the source addresses of innocent, non-infected clients or servers. In an embodiment of the present invention, the guard devices employ anti-spoofing mechanisms to prevent such erroneous blocking, such as anti-spoofing mechanisms described in the above-mentioned patent applications, or other techniques known in the art, such as SYN cookies or RST cookies.

FIG. 4 is a flow chart that schematically illustrates a method for screening and blocking traffic, in accordance with an embodiment of the present invention. As in the method described with reference to FIG. 3, the method is initiated at traffic diversion step 50, in accordance with the configuration of guard device 28. For some applications, the method of FIG. 4 is initiated simultaneously with the initiation of the method of FIG. 3. Alternatively, the method of FIG. 4 is initiated only when the blacklist contains at least one source address. Typically, when both the method of FIG. 3 and the method of FIG. 4 have been initiated, the two methods run in parallel processes, either on the same or different guard devices. Typically, the same types of traffic are diverted in both the methods of FIG. 3 and FIG. 4, although for some applications a broader or narrower set of packets is diverted in the method of FIG. 4 than in the method of FIG. 3. Diversion is typically effected using one or more of the methods described hereinabove with reference to FIG. 3.

After traffic has been diverted, guard device 28 intercepts all diverted packets, at packet interception step 52. Guard device 28 looks up the source address or subnetwork source address of each packet on the blacklist, at a blacklist look-up step 64. Guard device 28 determines whether the address of the packet is on the blacklist, at an address check step 66. If the address of the packet is not found on the blacklist, the guard device forwards the packet on its-normal path to its intended destination address, at a forward packet step 68.

On the other hand, if the address of the packet is found on the blacklist, guard device 28 blocks the further transmission of the packet, at a block step 70. Typically, the guard device simply discards the blocked packet, but alternatively, the guard device may analyze the packet contents (and may even take action to deliver the packet or remove it from the blacklist if the packet contents are found to be legitimate). Alternatively, at step 70 the guard device blocks transmission only of packets attempting to establish specific types of connections with servers outside the protected area. The guard device typically logs the receipt and blocking of the packet, at a log step 72. The logs generated at this step can be used by a system administrator for reporting or analysis. The guard device also adds information regarding the blocked packet to a blocked packet repository, such as a database, at a information recording step 74. Such information preferably includes a count of the number of packets blocked from each source address. When more than one guard device 28 is used, the multiple guard devices may share a common blocked packet repository, in order to enable broader statistical analysis of blockage patterns.

At a repository analysis step 76, at least one of the guard devices continuously or periodically analyzes the data in the blocked packet repository, in order to determine if the attack from a source or subnetwork source address has concluded. The guard device typically determines that an attack has concluded by detecting whether traffic from the source has subsided for a certain period of time, at a traffic subsidence check step 78. If malicious traffic has not subsided, the guard device leaves the source address on the blacklist, at a leave on blacklist step 80. On the other hand, if the traffic has subsided for a sufficient period of time, the guard device removes the source address from the blacklist, at a remove from blacklist step 82. Typically, the guard device generates an administrator alert or log entry when a source address is removed from the blacklist, at an administrator alert step 84.

FIG. 5 is a flow chart that schematically illustrates another method for detecting worm-generated traffic, in accordance with an embodiment of the present invention. This method may be used as a stand-alone detection method, or may be used in combination with other detection methods, such as the detection method described hereinabove with reference to FIG. 3. The method of FIG. 4 may be used to screen and block traffic from source addresses added to the blacklist by the method of FIG. 5. Alternatively, other methods may be used for creening and blocking traffic from sources identified by the method of FIG. 5.

In this method, a set of network addresses (such as IP addresses) assigned to protected area 30 (FIGS. 1 and 2) are designated as “trap” addresses, at a set trap step 90., The trap addresses are addresses that are routed to routers 22 by WAN 40, but are not in use by any of devices 26. Thus, any traffic addressed to these trap addresses is considered suspicious. Routers 22 are configured to divert traffic addressed to the trap addresses to at least one of guard devices 28, at a diversion step 92. Typically, diversion is effected by statically configuring the routers to divert to the guard devices all traffic with these destination addresses. Alternatively, other diversion methods may be used, as noted hereinabove with reference to FIG. 3.

When a packet addressed to a trap address enters protected area 30, the packet is received by one of routers 22, at a router receipt step 94. The router forwards the packet to a guard device, at a forwarding step 96. At an analysis step 98, the guard device analyzes the packet to determine whether it is indicative of worm activity. For example, the guard device may perform a statistical analysis on packets received from the same source or subnetwork source address, using information about the packet just received, combined with information about previously-received packets recorded in a statistical repository, as described hereinbelow with reference to step 102. According to one method for detecting traffic generated by a worm scanner, an unusually high number or rate of packets sent to the trap addresses from a single source or subnetwork source address is interpreted as an indication of worm activity. Alternatively or additionally, one or more of the worm detection methods described herein above with reference to packet analysis step 54 of FIG. 3 may be used for detecting traffic generated by a worn scanner and/or by a worm participating in a DDoS attack.

After performing the analysis, a determination is made regarding whether a worm-infected source has been identified, at a worm found checking step 100. If a worm has not been found, the guard device takes no action with respect to the trapped packet, at a no action step 102. On the other hand, if a worm has been identified, the source address or subnetwork source address, as the case may be, is added to a blacklist of suspected or known worm-infected sources, at a blacklist step 104, in a manner similar to that described above with reference to step 60, in FIG. 3. For applications utilizing the detection methods of FIGS. 3 and 5 in combination, infected source addresses may be stored on a common blacklist.

Alternatively, when a worm has been identified, the source address is not added to the blacklist, and, instead, the guard device initiates diversion of traffic from the source address to one or more guard devices for screening, but not necessarily blocking. Alternatively or additionally, when a worm has been identified, the guard device initiates diversion of all traffic entering the protected area of the network (including traffic from addresses other than the infected source address) to one or more guard devices for screening and possible blocking.

After adding the infected source to the blacklist or diverting traffic, guard device 28 typically generates a network administrator alert and/or log entry, at an alert generation step 106. An administrator can use this information to take preventive or corrective steps, such as those described hereinabove with reference to step 62 of FIG. 3.

Although the embodiments described herein make reference to specific communication protocols and conventions, the principles of the present invention may similarly be applied in other data communication contexts. For example, techniques described herein may be applied to protecting against worm-generated traffic sent over SMTP.

It will thus be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A method for screening packet-based communication traffic, comprising:
receiving at least a first data packet sent over a network from a source address to a destination address;
making a determination, by analyzing the first data packet, that the first data packet was generated by a worm; and
in response to the determination, blocking a second data packet sent over the network from the source address.

2. A method according to claim 1, wherein making the determination comprises:
comparing an attribute of the first data packet with a set of attributes of known worm-generated packets; and
blocking the first data packet when the attribute of the first data packet is found to match one of the attributes in the set.

3. A method according to claim 1, wherein blocking the second data packet comprises blocking the second data packet during a period of time commencing with making the determination that the first data packet was generated by the worm, and not blocking the second data packet thereafter.

4. A method according to claim 1, wherein the destination address is located within a protected area of the network, and wherein receiving the first data packet comprises receiving the first data packet from a source located outside the protected area.

5. A method according to claim 1, wherein the source address belongs to a network element located within a protected area of the network, wherein the destination address is located outside the protected area, and wherein receiving the first data packet comprises receiving the first data packet within the protected area.

6. A method according to claim 1, wherein making the determination comprises generating an administrator alert that the first data packet was generated by the worm.

7. A method according to claim 1, wherein the first data packet has a port designation, and wherein making the determination comprises determining that the port designation does not correspond to an application running at the destination address.

8. A method according to claim 1, wherein a server for an application resides at the destination address, and wherein making the determination comprises determining that the first data packet does not correspond to the application.

9. A method according to claim 1, wherein receiving the first data packet comprises receiving an Internet Protocol (IP) packet, and wherein making the determination comprises analyzing a pattern of a sequence number of the IP packet.

10. A method according to claim 1, wherein receiving the first data packet comprises receiving a Transport Control Protocol (TCP) SYN packet.

11. A method according to claim 10, wherein receiving the SYN packet comprises receiving multiple SYN packets addressed to multiple, respective destination addresses, and wherein making the determination comprises detecting a pattern of address scanning characteristic of the worm.

12. A method according to claim 1, wherein making the determination comprises determining that the destination address is invalid.

13. A method according to claim 12, wherein making the determination comprises designating one or more addresses as trap addresses, and determining that the destination address is one of the trap addresses.

14. A method according to claim 13, wherein making the determination comprises analyzing a rate of arrival of data packets sent from the source address to one or more of the trap addresses, so as to determine whether the packets were generated by the worm.

15. A method according to claim 1, wherein making the determination comprises storing on a blacklist the source address of the first data packet, and wherein blocking the second data packet comprises blocking the second data packet in response to the blacklist.

16. A method according to claim 15, wherein storing on the blacklist comprises removing the source address of the first data packet from the blacklist when it is determined that a rate of packets received from the source address has decreased.

17. A method according to claim 1, wherein receiving at least the first data packet comprises receiving multiple data packets from the source address, which are addressed to a plurality of respective destination addresses, and wherein making the determination comprises analyzing the multiple data packets sent from the source address.

18. A method according to claim 17, wherein making the determination comprises analyzing a rate of arrival of the data packets.

19. A method according to claim 17, wherein making the determination comprises comparing a pattern of the destination addresses with at least one pattern associated with known worm-generated traffic.

20. A method according to claim 17, wherein receiving the data packets from the source address comprises receiving the data packets from a plurality of source addresses belonging to a subnetwork, and wherein blocking the second data packet comprises blocking further data packets sent over the network from the subnetwork.

21. A method according to claim 1, wherein receiving the first data packet comprises intercepting the first data packet before the first data packet reaches the destination address, and comprising delivering the first data packet to the destination address when it is determined that the first data packet was not generated by the worm.

22. A method according to claim 21, wherein receiving the first data packet comprises receiving an Internet Protocol (IP) packet addressed to a particular port, and wherein intercepting the first data packet comprises intercepting the first data packet responsively to the particular port to which the IP packet is addressed.

23. A method according to claim 22, wherein intercepting the first data packet comprises intercepting the first data packet only if the first data packet comprises a Transport Control Protocol (TCP) SYN packet and the first data packet is addressed to port 80.

24. A method for analyzing packet-based communication traffic, comprising:
receiving multiple data packets sent over a network from a source address and addressed to a plurality of respective destination addresses;
determining a rate of sending the data packets to the plurality of destination addresses from the source address; and
in response to the rate, designating the source address as a source of malicious traffic.

25. A method according to claim 24, wherein receiving the data packets comprises receiving Transport Control Protocol (TCP) SYN packets.

26. A method according to claim 24, wherein designating the source address comprises designating the source address as a generator of worm-generated traffic.

27. A method according to claim 24, wherein receiving the data packets comprises receiving Internet Protocol (IP) packets having respective port designations, and wherein determining the rate comprises determining the rate of sending the data packets whose respective port designations do not correspond to applications running at the destination addresses.

28. A method according to claim 24, wherein determining the rate comprises determining the rate of sending data packets addressed to the destination addresses at which reside servers for an application, which application is different from that specified in the packets.

29. A method for analyzing packet-based communication traffic, comprising:
designating one or more network addresses as trap addresses;
receiving a data packet sent over the network from a source address to one of the trap addresses; and
in response to receiving the packet, designating the source address as a source of malicious traffic.

30. A method according to claim 29, wherein receiving the data packet comprises receiving a plurality of data packets sent over the network from the source address to one or more of the trap addresses, and wherein designating the source address comprises analyzing a rate of arrival of the data packets sent from the source address to the one or more of the trap addresses.

31. A method according to claim 29, wherein designating the source address comprises designating the source address as a generator of worm-generated traffic.

32. A method for analyzing packet-based communication traffic, comprising:
designating one or more network addresses as trap addresses;
receiving a data packet sent over the network to one of the trap addresses; and
in response to receiving the packet, initiating diversion of further data packets sent over the network from sources outside a protected area of the network, so as to prevent malicious traffic from reaching the protected area of the network.

33. A method according to claim 32, wherein initiating the diversion comprises preventing worm-generated traffic from reaching the protected area of the network.

34. A method according to claim 32, wherein initiating the diversion comprises determining that one of the further data packets was generated by a worm, and, in response to the determination, blocking delivery of the packet.

35. A method according to claim 32, wherein receiving the data packet comprises receiving a plurality of data packets sent over the network from a source address to one or more of the trap addresses, and wherein initiating the diversion comprises analyzing a rate of arrival of the data packets sent from the source address to the one or more of the trap addresses, and initiating the diversion responsively to the rate.

36. A method for analyzing packet-based communication traffic, comprising:
receiving a data packet sent over a network from a source address to a destination address;
comparing an attribute of the data packet with a set of attributes of known worm-generated packets; and
designating the source address as a source of worm-generated traffic when the attribute of the packet is found to match one of the attributes in the set.

37. A method according to claim 36, wherein the attribute comprises a length of the data packet.

38. A method according to claim 36, wherein the attribute comprises a signature of the packet.

39. Apparatus for screening packet-based communication traffic, comprising a guard device, which is adapted to receive at least a first data packet sent over a network from a source address to a destination address, to make a determination, by analyzing the first data packet, that the first data packet was generated by a worm, and, in response to the determination, to block a second data packet sent over the network from the source address.

40. Apparatus according to claim 39, and comprising a memory, which is adapted to store a set of attributes of known worm-generated packets, and wherein the guard is adapted to compare an attribute of the first data packet with the set, and to block the first data packet when the attribute of the first data packet is found to match one of the attributes in the set.

41. Apparatus according to claim 39, wherein the guard device is adapted to block the second data packet during a period of time commencing with making the determination that the first data packet was generated by the worm, and to not block the second data packet thereafter.

42. Apparatus according to claim 39, wherein the destination address is located within a protected area of the network, and wherein the guard device is adapted to receive the first data packet from a source located outside the protected area.

43. Apparatus according to claim 39, wherein the source address belongs to a network element located within a protected area of the network, wherein the destination address is located outside the protected area, and wherein the guard device is adapted to receive the first data packet within the protected area.

44. Apparatus according to claim 39, wherein the guard device is adapted to generate an administrator alert that the first data packet was generated by the worm.

45. Apparatus according to claim 39, wherein the first data packet has a port designation, and wherein the guard device is adapted to determine that the port designation does not correspond to an application running at the destination address.

46. Apparatus according to claim 39, wherein a server for an application resides at the destination address, and wherein the guard device is adapted to determine that the first data packet does not correspond to the application.

47. Apparatus according to claim 39, wherein first data packet comprises an Internet Protocol (IP) packet, and wherein the guard device is adapted to analyze a pattern of a sequence number of the IP packet.

48. Apparatus according to claim 39, wherein the first data packet comprises a Transport Control Protocol (TCP) SYN packet.

49. Apparatus according to claim 48, wherein the SYN packet comprises multiple SYN packets addressed to multiple, respective destination addresses, and wherein the guard device is adapted to detect a pattern of address scanning characteristic of the worm.

50. Apparatus according to claim 39, wherein the guard device is adapted to determine that the destination address is invalid.

51. Apparatus according to claim 50, wherein the guard device is adapted to designate one or more addresses as trap addresses, and to determine that the destination address is one of the trap addresses.

52. Apparatus according to claim 51, wherein the guard device is adapted to analyze a rate of arrival of data packets sent from the source address to one or more of the trap addresses, so as to determine whether the packets were generated by the worm.

53. Apparatus according to claim 39, and comprising a memory, which is adapted to store a blacklist, and wherein the guard device is adapted to store on the blacklist the source address of the first data packet, and to block the second data packet in response to the blacklist.

54. Apparatus according to claim 53, wherein the guard device is adapted to remove the source address of the first data packet from the blacklist when it is determined that a rate of packets received from the source address has decreased.

55. Apparatus according to claim 39, wherein the guard device is adapted to receive multiple data packets from the source address, which are addressed to a plurality of respective destination addresses, and to analyze the multiple data packets sent from the source address.

56. Apparatus according to claim 55, wherein the guard device is adapted to analyze a rate of arrival of the data packets, so as to determine whether the packets were generated by the worm.

57. Apparatus according to claim 55, and comprising a memory, which is adapted to store at least one reference pattern associated with known worm-generated traffic, and wherein the guard device is adapted to compare a pattern of the destination addresses with the reference pattern, so as to determine whether the packets were generated by the worm.

58. Apparatus according to claim 55, wherein the guard device is adapted to receive the data packets from a plurality of source addresses belonging to a subnetwork, and to block further data packets sent over the network from the subnetwork.

59. Apparatus according to claim 39, wherein the guard device is adapted to intercept the first data packet before the first data packet reaches the destination address, and to deliver the first data packet to the destination address when it is determined that the first data packet was not generated by the worm.

60. Apparatus according to claim 59, wherein the first data packet comprises an Internet Protocol (IP) packet addressed to a particular port, and wherein the guard device is adapted to intercept the IP packet responsively to the particular port to which the IP packet is addressed.

61. Apparatus according to claim 60, wherein the guard device is adapted to intercept the first data packet only if the first data packet comprises a Transport Control Protocol (TCP) SYN packet and the first data packet is addressed to port 80.

62. Apparatus for analyzing packet-based communication traffic, comprising a guard device, which is adapted to receive multiple data packets sent over a network from a source address and addressed to a plurality of respective destination addresses, to determine a rate of sending the data packets to the plurality of destination addresses from the source address, and, in response to the rate, to designate the source address as a source of malicious traffic.

63. Apparatus according to claim 62, wherein the data packets comprise Transport Control Protocol (TCP) SYN packets.

64. Apparatus according to claim 62, wherein the guard device is adapted to designate the source address as a generator of worm-generated traffic.

65. Apparatus according to claim 62, wherein the data packets comprise Internet Protocol (IP) packets having respective port designations, and wherein the guard device is adapted to determine the rate of sending the data packets whose respective port designations do not correspond to applications running at the destination addresses, so as to determine whether the data packets represent malicious traffic.

66. Apparatus according to claim 62, wherein the guard device is adapted to determine the rate of sending data packets addressed to the destination addresses at which reside servers for an application, which application is different from that specified in the packets, so as to determine whether the data packets represent malicious traffic.

67. Apparatus for analyzing packet-based communication traffic, comprising a guard device, which is adapted to designate one or more network addresses as trap addresses, to receive a data packet sent over the network from a source address to one of the trap addresses, and, in response to receiving the packet, to designate the source address as a source of malicious traffic.

68. Apparatus according to claim 67, wherein the guard device is adapted to receive a plurality of data packets sent over the network from the source address to one or more of the trap addresses, and to analyze a rate of arrival of the data packets sent from the source address to the one or more of the trap addresses, so as to determine whether the data packets represent malicious traffic.

69. Apparatus according to claim 67, wherein the guard device is adapted to designate the source address as a generator of worm-generated traffic.

70. Apparatus for analyzing packet-based communication traffic, comprising a guard device, which is adapted to designate one or more network addresses as trap addresses, to receive a data packet sent over the network to one of the trap addresses, and, in response to receiving the packet, to initiate diversion of further data packets sent over the network from sources outside a protected area of the network, so as to prevent malicious traffic from reaching the protected area of the network.

71. Apparatus according to claim 70, wherein the guard device is adapted to initiate the diversion so as to prevent worm-generated traffic from reaching the protected area of the network.

72. Apparatus according to claim 70, wherein the guard device is adapted to determine that one of the further data packets was generated by a worm, and, in response to the determination, to block delivery of the packet.

73. Apparatus according to claim 70, wherein the guard device is adapted to receive a plurality of data packets sent over the network from a source address to one or more of the trap addresses, to analyze a rate of arrival of the data packets sent from the source address to the one or more of the trap addresses, and to initiate the diversion responsively to the rate.

74. Apparatus for analyzing packet-based communication traffic, comprising a guard device, which is adapted to receive a data packet sent over a network from a source address to a destination address, to compare an attribute of the data packet with a set of attributes of known worm-generated packets, and to designate the source address as a source of worm-generated traffic when the attribute of the packet is found to match one of the attributes in the set.

75. Apparatus according to claim 74, wherein the attribute comprises a length of the data packet.

76. Apparatus according to claim 74, wherein the attribute comprises a signature of the packet.

77. A computer software product for screening packet-based communication traffic, the product comprising a computer-readable medium in which program instructions are stored, which instructions, when read by a computer, cause the computer to receive at least a first data packet sent over a network from a source address to a destination address, to make a determination, by analyzing the first data packet, that the first data packet was generated by a worm, and, in response to the determination, to block a second data packet sent over the network from the source address.

78. A product according to claim 77, wherein the instructions cause the computer to read from a memory a set of attributes of known worm-generated packets, to compare an attribute of the first data packet with the set, and to block the first data packet when the attribute of the first data packet is found to match one of the attributes in the set.

79. A product according to claim 77, wherein the instructions cause the computer to block the second data packet during a period of time commencing with making the determination that the first data packet was generated by the worm, and to not block the second data packet thereafter.

80. A product according to claim 77, wherein the destination address is located within a protected area of the network, and wherein the instructions cause the computer to receive the first data packet from a source located outside the protected area.

81. A product according to claim 77, wherein the source address belongs to a network element located within a protected area of the network, wherein the destination address is located outside the protected area, and wherein the instructions cause the computer to receive the first data packet within the protected area.

82. A product according to claim 77, wherein the instructions cause the computer to generate an administrator alert that the first data packet was generated by the worm.

83. A product according to claim 77, wherein the first data packet has a port designation, and wherein the instructions cause the computer to determine that the port designation does not correspond to an application running at the destination address.

84. A product according to claim 77, wherein a server for an application resides at the destination address, and wherein the instructions cause the computer to determine that the first data packet does not correspond to the application.

85. A product according to claim 77, wherein first data packet comprises an Internet Protocol (IP) packet, and wherein the instructions cause the computer to analyze a pattern of a sequence number of the IP packet.

86. A product according to claim 77, wherein the first data packet comprises a Transport Control Protocol (TCP) SYN packet.

87. A product according to claim 86, wherein the SYN packet comprises multiple SYN packets addressed to multiple, respective destination addresses, and wherein the instructions cause the computer to detect a pattern of address scanning characteristic of the worm.

88. A product according to claim 77, wherein the instructions cause the computer to determine that the destination address is invalid.

89. A product according to claim 88, wherein the instructions cause the computer to designate one or more addresses as trap addresses, and to determine that the destination address is one of the trap addresses.

90. A product according to claim 89, wherein the instructions cause the computer to analyze a rate of arrival of data packets sent from the source address to one or more of the trap addresses, so as to determine whether the packets were generated by the worm.

91. A product according to claim 77, wherein the instructions cause the computer to store on a blacklist the source address of the first data packet, and to block the second data packet in response to the blacklist.

92. A product according to claim 91, wherein the instructions cause the computer to remove the source address of the first data packet from the blacklist when it is determined that a rate of packets received from the source address has decreased.

93. A product according to claim 77, wherein the instructions cause the computer to receive multiple data packets from the source address, which are addressed to a plurality of respective destination addresses, and to analyze the multiple data packets sent from the source address.

94. A product according to claim 93, wherein the instructions cause the computer to analyze a rate of arrival of the data packets, so as to determine whether the packets were generated by the worm.

95. A product according to claim 93, wherein the instructions cause the computer to read from a memory at least one reference pattern associated with known worm-generated traffic, and to compare a pattern of the destination addresses with the reference pattern, so as to determine whether the packets were generated by the worm.

96. A product according to claim 93, wherein the instructions cause the computer to receive the data packets from a plurality of source addresses belonging to a subnetwork, and to block further data packets sent over the network from the subnetwork.

97. A product according to claim 77, wherein the instructions cause the computer to intercept the first data packet before the first data packet reaches the destination address, and to deliver the first data packet to the destination address when it is determined that the first data packet was not generated by the worm.

98. A product according to claim 97, wherein the first data packet comprises an Internet Protocol (IP) packet addressed to a particular port, and wherein the instructions cause the computer to intercept the IP packet responsively to the particular port to which the IP packet is addressed.

99. A product according to claim 98, wherein the instructions cause the computer to intercept the first data packet only if the first data packet comprises a Transport Control Protocol (TCP) SYN packet and the first data packet is addressed to port 80.

100. A computer software product for analyzing packet-based communication traffic, the product comprising a computer-readable medium in which program instructions are stored, which instructions, when read by a computer, cause the computer to receive multiple data packets sent over a network from a source address and addressed to a plurality of respective destination addresses, to determine a rate of sending the data packets to the plurality of destination addresses from the source address, and, in response to the rate, to designate the source address as a source of malicious traffic.

101. A product according to claim 100, wherein the data packets comprise Transport Control Protocol (TCP) SYN packets.

102. A product according to claim 100, wherein the instructions cause the computer to designate the source address as a generator of worm-generated traffic.

103. A product according to claim 100, wherein the data packets comprise Internet Protocol (IP) packets having respective port designations, and wherein the instructions cause the computer to determine the rate of sending the data packets whose respective port designations do not correspond to applications running at the destination addresses, so as to determine whether the data packets represent malicious traffic.

104. A product according to claim 100, wherein the instructions cause the computer to determine the rate of sending data packets addressed to the destination addresses at which reside servers for an application, which application is different from that specified in the packets, so as to determine whether the data packets represent malicious traffic.

105. A computer software product for analyzing packet-based communication traffic, the product comprising a computer-readable medium in which program instructions are stored, which instructions, when read by a computer, cause the computer to designate one or more network addresses as trap addresses, to receive a data packet sent over the network from a source address to one of the trap addresses, and, in response to receiving the packet, to designate the source address as a source of malicious traffic.

106. A product according to claim 105, wherein the instructions cause the computer to receive a plurality of data packets sent over the network from the source address to one or more of the trap addresses, and to analyze a rate of arrival of the data packets sent from the source address to the one or more of the trap addresses, so as to determine whether the data packets represent malicious traffic.

107. A product according to claim 105, wherein the instructions cause the computer to designate the source address as a generator of worm-generated traffic.

108. A computer software product for analyzing packet-based communication traffic, the product comprising a computer-readable medium in which program instructions are stored, which instructions, when read by a computer, cause the computer to designate one or more network addresses as trap addresses, to receive a data packet sent over the network to one of the trap addresses, and, in response to receiving the packet, to initiate diversion of further data packets sent over the network from sources outside a protected area of the network, so as to prevent malicious traffic from reaching the protected area of the network.

109. A product according to claim 108, wherein the instructions cause the computer to initiate the diversion so as to prevent worm-generated traffic from reaching the protected area of the network.

110. A product according to claim 108, wherein the instructions cause the computer to determine that one of the further data packets was generated by a worm, and, in response to the determination, to block delivery of the packet.

111. A product according to claim 108, wherein the instructions cause the computer to receive a plurality of data packets sent over the network from a source address to one or more of the trap addresses, to analyze a rate of arrival of the data packets sent from the source address to the one or more of the trap addresses, and to initiate the diversion responsively to the rate.

112. A computer software product for analyzing packet-based communication traffic, the product comprising a computer-readable medium in which program instructions are stored, which instructions, when read by a computer, cause the computer to receive a data packet sent over a network from a source address to a destination address, to compare an attribute of the data packet with a set of attributes of known worm-generated packets, and to designate the source address as a source of worm-generated traffic when the attribute of the packet is found to match one of the attributes in the set.

113. A product according to claim 112, wherein the attribute comprises a length of the data packet.

114. A product according to claim 112, wherein the attribute comprises a signature of the packet.
